(19) United States
(12) Patent Application Publication
(10) Pub. No.: US 2008/0038442 A1
(43) Pub. Date: Feb. 14, 2008

(54) CRISPS HAVING A HIGH DIETARY FIBER CONTENT AND FOOD PRODUCTS CONTAINING SAME

(76) Inventors: Dorothy J. Peterson, St. John, IN (US); Kathie Manirath, Shakopee, MN (US); Norris Sun, Plymouth, MN (US); Wade N. Schmelzer, St. Louis Park, MN (US); Ann M. Stark, Marion, IA (US); Laura H. Crosby, Eden Prairie, MN (US); Ansui Xu, Carmel, IN (US); Stefan K. Baier, Plymouth, MN (US); William R. Aimutis JR., Blaine, MN (US)

Correspondence Address: FISH & RICHARDSON P.C., PO BOX 1022, MINNEAPOLIS, MN, 55440-1022, US

(21) Appl. No.: 11/738,139

(22) Filed: Apr. 20, 2007

Related U.S. Application Data
(60) Provisional application No. 60/794,083, filed on Apr. 21, 2006.
(60) Provisional application No. 60/864,544, filed on Nov. 6, 2006.

(51) Int. Cl. A23L 1/05; A23L 1/0522; A23L 1/0528; A23L 1/2165

(52) U.S. Cl. 426/622; 426/618; 426/637; 426/661

(57) ABSTRACT

A crisp that includes a resistant starch and a puffing agent, where the crisp has a total dietary fiber content of at least 10% by weight, as well as food products that include the crisp in combination with a base food.

### CROSS REFERENCE TO RELATED APPLICATIONS

This invention claims priority to (1) U.S. Provisional Application Ser. No. 60/794,083 filed Apr. 21, 2006, and (2) U.S. Provisional Application Ser. No. 60/864,544 filed Nov. 6, 2006, both of which are incorporated by reference in their entirety.

### TECHNICAL FIELD

This invention relates to increasing the dietary fiber content of foods.

### BACKGROUND

Recent studies suggest that diets high in dietary fiber offer health benefits, including decreased risk of cardiovascular disease, cancer, gastrointestinal problems, and obesity. Accordingly, it would be desirable to increase the fiber content of various foods without compromising the food's taste and texture.

### SUMMARY

Crisps are described that include a resistant starch and a puffing agent. “Crisps” are extruded compositions that expand during extrusion upon the evaporation of moisture. The crisps may exist in a variety of shapes and sizes with varying densities, including, for example, pellets.

The crisps described herein have a total dietary fiber content of at least 10% by weight. In some cases, the total dietary fiber content is at least 20%, 30%, or 40% by weight. Examples of suitable resistant starches include phosphorylated starches. The resistant starches may be derived from a variety of sources, including, for example, corn and tapioca.

The puffing agent aids expansion during extrusion. Examples of suitable puffing agents include corn starch, corn flour, corn meal, potato starch, potato flour, wheat starch, wheat flour, rice flour, tapioca starch, pregel corn meals, pregel whole corn flours and meals, and combinations thereof. In some embodiments, the puffing agent may be a modified food starch.

The crisps may optionally contain one or more fibrous ingredients. The fibrous ingredients, in turn, may be water-soluble or water-insoluble. Representative examples include inulin, corn fiber, corn bran, beta glucans (e.g., barley beta glucan), psyllium, polydextrose, and combinations thereof. The crisps may be used alone, bound together to form clusters, or incorporated in a variety of food products for the purpose of supplying dietary fiber.

The crisps have a number of desirable properties. In general, the color, measured using an Agtron colorimeter), is characterized by red values in the range of about 67.3 to about 77.3, and yellow values in the range of about 56.2 to about 68.5. The crisps also exhibit good sensory attributes, including crispness and persistence of crisp (defined in the Examples section, below) and retain those attributes even after prolonged soaking in liquids such as milk. In addition, the crisps exhibit acceptable moisture absorption even when placed in high humidity environments for extended periods of time.

The details of one or more embodiments of the invention are set forth in the accompanying drawings and the description below. Other features, objects, and advantages of the invention will be apparent from the description, and from the claims.

### DETAILED DESCRIPTION

The crisps include a resistant starch, a puffing agent, and, optionally, one or more fibrous ingredients such as inulin, corn fiber, corn bran, beta glucans, psyllium, and polydextrose. The crisps may contain other ingredients as well, including coloring agents, flavoring agents (e.g., cocoa powder), seasonings, peanut powder, sweeteners, and the like, which may be incorporated in the crisp itself, coated onto the crisp, or a combination thereof.

The crisps are formulated to contain at least 10% by weight total dietary fiber. In some cases, the total dietary fiber content is at least 20%, 30%, or 40% by weight. Total dietary fiber is measured according to AOAC method 991.43. In cases where the crisp included a source of soluble fiber (e.g., inulin) in addition to the starch components, the results are adjusted to reflect the content of the soluble fiber, as is known in the art.

The crisps are prepared using an extrusion process. As a person of ordinary skill will appreciate, the specific extrusion conditions will vary according to the particular equipment used. In general, the extrusion conditions are selected to cause the extruded composition to puff and thereby achieve a desired level of crispness that is retained following extrusion. The selection of these conditions is within the ability of a person of skill in the art, in light of the following guidelines.

Multi-zone, twin screw extruders having a combination of reverse and forward screw elements have been found to be useful for preparing the crisps. A blend containing the resistant starch, puffing agent, and, optionally, additional fibrous ingredients is first exposed to steam to pre-condition the blend. The pre-conditioned blend then enters the extruder. In general, the barrel temperature of the individual zones of the extruder is selected to be in the range of 250-350° F.

The blend is extruded through a die. The die configuration, including the dimensions of the holes, is selected based upon the desired size and shape of the crisp. A variety of sizes and shapes can be prepared. The pressure at the die head is selected such that it is sufficient to cause the blend to puff. The particular pressure needed for the desired degree of puffing is a function of the individual extruder and its operating conditions. Following extrusion, the crisps are air dried to less than 3% moisture by weight. Drying may be conducted in batch or continuous fashion.

A representative extrusion is conducted under the following conditions.

Resistant starch, puffing agent, and any additional fibrous ingredients at a prescribed ratio are pre-blended in a blender for 30 minutes. A K-tron feeder is sued to achieve an average feed rate of 1350-1400 lbs/hr to the preconditioner and extruder. In the preconditioner, steam is introduced to ensure consistency in feeding the raw blend into the extruder.

Extrusion is carried out using a Buhler twin screw extruder with a length to diameter (L/D) ratio of 20:1 with the screw configuration having a combination of forward and reverse screw elements. The extruder die head is manufactured with 72 openings, but 36 of these holes are plugged. Water is added to the preconditioned blend at a rate of 3.7 to 4.0 pounds per minute just prior to entering the extruder. The extruder shaft speed is set at 35 rpm. During extrusion, the extruder zones are heated using a steam jacketed system to achieve to the following set points for barrel temperatures:

Zone 3: 250-260° F.

Zone 4: 270-280° F.

Zone 5: 280-290° F.

Upon reaching the target barrel temperature for Zone 5, which is the zone before the die head, the steam to this zone is turned off. During extrusion, the pressure before the die fluctuates between 1000 to 2000 psi.

Using a cutter system, the extruded product is then cut at a knife speed of 60-70% to achieve the desired size. The particles generally have a moisture content, upon exiting the extruder, in the range of 9-13% by weight. The extruded particles are dried on a belt conveyor at 365° F. in an oven to achieve a final moisture of less than 3% by weight.

Resistant Starch

The resistant starch may be a phosphorylated starch. It can be phosphorylated with one or more agents selected from sodium trimetaphosphate (STMP) and sodium tripolyphosphate (STPP). In some embodiments, the starch is phosphorylated with STMP or a mixture of STMP and STPP.

In some embodiments, the starch is phosphorylated with sodium trimetaphosphate (STMP) and sodium tripolyphosphate (STPP). For example, the starch may be phosphorylated according to methods described in U.S. Pat. No. 5,855,946 or 6,299,907, the entire contents of which are hereby incorporated by reference. The starch may be phosphorylated in the presence of sodium chloride or sodium sulfate in an aqueous slurry reaction at basic pH with moderate heating. The starch may be phosphorylated with about 1-20% by weight STMP, either alone or in combination with STPP, based upon the weight of the unmodified starch taken as 100% by weight. The starch may also be phosphorylated with STMP and STPP at a weight-to-weight STMP:STPP ratio greater than 90:10, greater than 95:5, greater than 99:1, or greater than 99.9:1.

The resistant starch may be derived from a variety of sources, including wild-type and mutant hybrid plants. Representative examples include common corn, tapioca, wheat, potato, rice, sweet potato, arrowroot, sago, pea (smooth or wrinkled), barley, banana, manioc, oat, mung bean, and corn. The starch may be modified to alter its natural composition or structure. The alteration can be a result of genetic engineering, controlled plant breeding, or chemical modification. In addition, starches from different sources may be combined. For example, a blend of tapioca and corn starch can be used.

The resistant starch may be a high amylose starch that includes at least 50%, at least 60%, at least 80%, or at least 90% amylose by weight of the starch. For example, the starch may be a phosphorylated high amylose starch derived from corn. Non-limiting examples of a high amylose corn starch include Class V (at least about 50% by weight amylose), Class VII (at least about 70% by weight amylose), and Class IX (at least about 90% by weight amylose).

The resistant starch may also be derived from tapioca. The tapioca-derived phosphorylated starch may include about 10-25%, about 15-25%, or about 15-20% by weight amylose.

The amount of resistant starch is selected to maximize dietary fiber, while at the same time permitting the composition to be extruded to form the crisp. In some embodiments, the crisp includes at least 45% by weight based upon the total weight of the crisp. In other embodiments, the amount of phosphorylated starch is at least 50% by weight or at least 60% by weight.

Puffing Agent

The purpose of the puffing agent is to aid expansion of the composition during extrusion to create the crisp. Typically, the amount of puffing agent is no greater than about 50% or, in some embodiments, no greater than 35% by weight based upon the total weight of the crisp. Examples of suitable puffing agents include corn starch, corn flour, corn meal, potato starch, potato flour, wheat starch, wheat flour, rice flour, tapioca starch, pregel corn meals, pregel whole corn flours and meals, and combinations thereof. In some embodiments, the puffing agent may be a modified food starch such as crosslinked waxy maize starch.

Applications of Crisps

The crisps may be used as is, or may be bound together, e.g., with a sweetener, to form clusters. The crisps may also be incorporated in a variety of food products. Representative examples of suitable food products include baked goods (e.g., cookies, muffins, and the like), bars, cereals, confections (e.g., chocolate), trail mixes, dairy products (e.g., ice cream, yogurt, and the like), snack products (e.g., extruded snacks, stand alone snacks, chips, pretzels, curls, and the like), meats, garnishes, toppings, coatings, and breading (e.g., for coating or stuffing foods). The crisps may also be flavored, sweetened, and/or seasoned if desired.

### EXAMPLES

### Example Set A

Crisps were prepared according to general extrusion process described above using the following composition:

(a) ActiStar™ RT 75330 (a phosphorylated resistant food starch derived from tapioca that is commercially available from Cargill, Inc.): 55% by weight.

(b) StabiTex™ 06330 (a crosslinked waxy maize starch commercially available from Cargill, Inc.): 35% by weight.

(c) Oliggo-Fiber® Instant (a native inulin with an average degree of polymerization of 10 commercially available from Cargill, Inc.): 10% by weight.

The resulting crisps had a total dietary fiber (TDF) value of 30-40%. TDF is measured according to AOAC 991.43. This figure does not include soluble fiber from inulin. The crisps also exhibited the following color values (measured using an Agtron colorimeter): Red=73-76; Yellow=62-65.

The sensory and water absorption properties of the crisps were tested as follows.

a. Sensory Testing

Five texture attributes of the crisps were evaluated by a third party testing company (21^{st} Sensory, Inc.) using a methodology based on applying “universal” 15 point scales. The scales are relational, thereby allowing the intensity of unrelated attributes to be compared to one another using the same scales. When interpreting the data, attributes with the highest scores are the strongest, most dominant flavors. The end point of 15 represents the concept of “extreme” for the particular attribute.

The tests were conducted over a period of 3 days using 10 highly trained descriptive panelists led by a panel leader. The crisps, as well as 3 additional samples, were evaluated based upon five texture attributes: crispness, persistence of crisp, hardness, denseness, and dissolvability. Each sample was evaluated dry and also after immersion in 2% milk for periods of 3, 6, and 10 minutes. All samples for evaluations in milk were measured and poured into 4-oz coded cups with lids. The samples evaluated dry were poured into 2-oz coded cups with lids. The milk was measured to ½ cup, poured into the 4-oz cups, and held in a refrigerator until needed.

The 5 attributes were measured against the reference samples shown below;

(1) Crispness: Measure the sound or pitch of the force with which a product breaks or fractures.

| Reference Sample | Reference Value |
|---|---|
| Quaker ® Low Fat Chewy Chocolate | 2.0 |
| Chunk Granola Bars (The Quaker Oats | |
| Company) | |
| RITZ Crackers (Nabisco) | 5.0 |
| Cheerios ® (General Mills) | 7.0 |
| Cheetos ® Puffs (Frito Lay Co.) | 9.5 |
| Original Shredded Wheat Spoon Size ® | 10.5 |
| (Post) | |
| Old London Plain Melba Toast | 17.0 |

(2) Persistence of Crisp: Count the number of chews until the crispness sound drops off, while chewing the bolus.

| Reference Sample | Reference Value |
|---|---|
| Cheetos ® Puffs (Frito Lay Co.) | 5.0 |
| RITZ Crackers (Nabisco) | 7.0 |
| Baked! Lays ® Original Potato Crisps | 9.0 |
| (Frito Lay Co.) | |
| Wheaties (General Mills) | 11.0 |

(3) Hardness: Measure the force required to bite through sample with molars.

| Reference Sample | Reference Value |
|---|---|
| Philadelphia ® Cream Cheese (Kraft) | 1.0 |
| Cheerios ® (General Mills) | 5.5 |
| Wheaties (General Mills) | 7.0 |
| Pringles ® Original Potato Crisps | 7.5 |
| Planters Peanuts | 9.5 |
| Whole Almond | 11.0 |

(4) Denseness: Measure the compactness of the cross section of sample while biting completely through with the molars.

| Reference Sample | Reference Value |
|---|---|
| Kellogg's ® Rice Krispies ® | 2.5 |
| Cheerios ® (General Mills) | 4.0 |
| Whoppers ® Malted Milk Balls (The | 6.0 |
| Hershey Company) | |
| Yellow American Cheese | 9.5 |

(5) Dissolvability: Measure the degree to which the sample dissolves. Scale goes from 3.0 (does not dissolve) to 15.0 (highly dissolvable).

| Reference Sample | Reference Value |
|---|---|
| Wheaties (General Mills) | 3.0 |
| Cheerios ® (General Mills) | 6.0 |
| Kix (General Mills) | 6.0 |
| Cheetos ® Puffs (Frito Lay Co.) | 12.0 |
| Cotton Candy | 15.0 |

The 4 samples that were the subject of the evaluation were labeled as follows:

A: Crisps containing 55% ActiStar™ RT 75330 resistant starch, 35% StabiTex™ 06330 starch, and 10% Oliggo-Fiber® Instant inulin (prepared as described above);

B: Kerry Crisp Rice #1050 (Kerry Ingredients, Beloit, Wis.);

C: Beta Glucan Crisp RD 28301-33.4B (Kerry Ingredients, Beloit, Wis.);

D: Oat Fiber Crisp #2050 (Nuvex Ingredients, Inc., Blue Earth, Minn.).

The results of the sensory testing are shown in Tables A1 and A2, below.

TABLE A1
SENSORY TESTING RESULTS (DRY)

Sample

| | A | B | C | D |
|---|---|---|---|---|
| Crispness | 14.7 | 9.9 | 5.8 | 1.4 |
| Persistence of | 7.2 | 4.9 | 5.0 | 0.8 |
| Crisp | | | | |
| Hardness | 8.2 | 5.4 | 10.3 | 9.7 |
| Denseness | 4.6 | 3.6 | 6.6 | 7.9 |

TABLE A2
SENSORY TESTING RESULTS (2% MILK)

Sample

| | A | B | C | D |
|---|---|---|---|---|
| Initial | | | | |
| Crispness | 13.5 | 11.2 | 9.1 | 2.1 |
| Persistence of | 15.4 | 10.6 | 14.3 | 4.4 |
| Crisp | | | | |
| Hardness | 8.6 | 4.8 | 10.3 | 9.3 |
| Denseness | 4.6 | 3.1 | 6.8 | 7.7 |
| Dissolvability | 3.6 | 7.6 | 2.4 | 2.3 |
| 3 Minutes | | | | |
| Crispness | 10.8 | 6.0 | 6.3 | 0.7 |
| Persistence of | 13.3 | 7.8 | 11.1 | 1.0 |
| Crisp | | | | |
| Hardness | 7.8 | 3.7 | 9.4 | 9.7 |
| Denseness | 4.8 | 3.7 | 7.4 | 8.2 |
| Dissolvability | 3.7 | 7.2 | 2.4 | 2.5 |
| 6 Minutes | | | | |
| Crispness | 9.0 | 3.4 | 4.0 | 0.0 |
| Persistence of | 11.7 | 3.9 | 9.2 | 0.0 |
| Crisp | | | | |
| Hardness | 7.4 | 3.1 | 8.5 | 9.8 |
| Denseness | 5.4 | 4.5 | 7.7 | 8.8 |
| Dissolvability | 3.8 | 6.8 | 2.6 | 2.7 |
| 10 Minutes | | | | |
| Crispness | 6.5 | 1.2 | 1.4 | 0.0 |
| Persistence of | 11.3 | 1.0 | 3.0 | 0.0 |
| Crisp | | | | |
| Hardness | 6.8 | 2.3 | 8.1 | 9.5 |
| Denseness | 5.7 | 5.1 | 8.0 | 9.4 |
| Dissolvability | 3.9 | 6.9 | 2.8 | 2.9 |

The results demonstrate that the crisps (i.e., Sample A) initially had desirable sensory attributes such as crispness, and retained those desirable attributes even after extended soaking in milk.

b. Moisture Absorption

The percent moisture gain/loss over time of the crisps was determined as follows.

Two crisp samples were weighed and their initial weight recorded. They were then placed for either 4 or 8 weeks in one of 4 humidity-controlled environments created 110 using a saturated salt solution contained in a sealed dessicator. The dessicator was equipped with a hygrometer for measuring relative humidity. The particular salt solution was selected based upon the desired relative humidity of the environment. The following environments were used:

| Relative Humidity (RH) | Water Activity (Aw) | Saturated Solution |
|---|---|---|
| 33% | 0.33 | Magnesium chloride |
| 52% | 0.52 | Magnesium nitrate |
| 64% | 0.64 | Sodium nitrite |
| 85% | 0.85 | Potassium chloride |

Prior to addition of the samples, the salt solutions were allowed to equilibrate in the dessicators for about 3 weeks.

At the conclusion of the 4 or 8 week period, each sample was removed from the environment and weighed. Its percent moisture gain or loss was then recorded. The results are shown in Table A3, below. The results demonstrate that the crisps exhibit acceptable moisture absorption even when placed in high humidity environments for extended periods of time. Low moisture uptake, in turn, means good retention of crispness and good shelf life.

TABLE A3
MOISTURE ABSORPTION

| | Time, | % | Initial | Final | % | Average |
|---|---|---|---|---|---|---|
| Sample | Weeks | RH | Wt (g) | Wt (g) | gain/loss | % |
| 1(a) | 4 | 33 | 5.0097 | 5.1942 | 3.6829 | |
| 1(b) | 4 | 33 | 5.0106 | 5.1947 | 3.6741 | 3.6786 |
| 2(a) | 4 | 52 | 5.1175 | 5.4458 | 6.4152 | |
| 2(b) | 4 | 52 | 5.1719 | 5.5138 | 6.6107 | 6.513 |
| 3(a) | 4 | 64 | 5.0133 | 5.4291 | 8.2939 | |
| 3(b) | 4 | 64 | 5.0725 | 5.5027 | 8.4810 | 8.3875 |
| 4(a) | 4 | 85 | 5.0161 | 5.8054 | 15.7353 | |
| 4(b) | 4 | 85 | 5.1706 | 6.0421 | 16.8549 | 16.2951 |
| 5(a) | 8 | 33 | 5.0719 | 5.2583 | 3.6752 | |
| 5(b) | 8 | 33 | 5.0059 | 5.1906 | 3.6896 | 3.6824 |
| 6(a) | 8 | 52 | 5.2772 | 5.6488 | 7.0416 | |
| 6(b) | 8 | 52 | 5.3841 | 5.7498 | 6.7922 | 6.9169 |
| 7(a) | 8 | 64 | 5.0201 | 5.4765 | 9.0915 | |
| 7(b) | 8 | 64 | 5.0320 | 5.4749 | 8.8017 | 8.9466 |
| 8(a) | 8 | 85 | 5.0591 | 5.9307 | 17.2284 | |
| 8(b) | 8 | 85 | 5.0094 | 5.9200 | 18.1778 | 17.7031 |

c. Comparative Textural Analysis of Crisps

The textural characteristics of the crisps were evaluated using a TA-HDi® texture analyzer (available from Stable Microsystems™, Suffey, UK). The system was equipped with an Ottawa cell, a watertight base plate and a flat plate plunger probe. The settings of the texture analyzer were specified as shown in Table A4.

TABLE A4
TA-Hdi ® Settings

| Mode | Measure Force in Compression | |
|---|---|---|
| Option | Return to Start | |
| Pre-Test Speed | 2.0 | mm/s |
| Test Speed | 1.0 | mm/s |
| Post-Test Speed | 10.0 | mm/s |
| Trigger Type and Force | Auto | (50 g) |
| Load Cell | 500 | kg |

The surface of the base plate was calibrated as the zero position for the probe. Then, the Ottawa cell was filled with crisps to about 40 mm above the base plate. For each test, data collection was initiated after contact of the plunger probe with the crisps yielded a trigger compression force of 50 grams. The test continued until the probe penetrated 25% of the sample height in the cell, causing fracturing of the crisps during compression. The number of fracture events was quantified (an event occurred when the drop in force exceeded 150 grams). Both the average drop in force (defined as average dropoff) and linear distance were determined as measures of the crispness of the product. In addition, hardness was determined by the maximum force value. For comparison, texture analysis was also performed on other commercially available crisps, including Crisp Rice #13 and Crisp Rice #1056 (available from Kerry Ingredients) and Rice Krispies® (Kellogg's®). Texture analysis was conducted on 5 to 7 independent samples for each crisp product. The results of the comparative assessment are shown in Table A5. Both indicators of crispness, average dropoff and mean linear distance, are noticeably higher for the crisps, as compared to any of the commercially available crisp samples.

TABLE A5
Texture Analysis

| Crisp | Samples | Average Number | Average | Mean Linear | Average Hardness, |
|---|---|---|---|---|---|
| Sample | (n) | Of Peaks | Dropoff (g) | Distance | Maximum Force (g) |
| Crisps | 6 | 65 | 1523 ± 294 | 4638 ± 571 | 62303 ± 26945 |
| Crisp Rice #13 | 7 | 20 | 789 ± 223 | 2802 ± 245 | 246769 ± 20102 |
| Crisp Rice #1056 | 7 | 68 | 822 ± 123 | 2259 ± 302 | 102885 ± 9501 |
| Rice Krispies ® | 5 | 22 | 270 ± 25 | 581 ± 96 | 19275 ± 5970 |

d. Food Formulations

The following food products were prepared using the above-described fiber crisps. All percentages are given in weight percent unless otherwise noted.

1. Ice Cream Bar

| INGREDIENTS | Wt % |
|---|---|
| Frozen Ice Cream Bar | 63.9 |
| Chocolate Coating | 32.5 |
| Fiber Crisps | 3.6 |
| Total | 100.0 |

The ice cream bar was prepared by adding the fiber crisps to the chocolate coating and maintaining a homogeneous mixture of the two ingredients by agitation, while keeping the mixture at least 10° F. higher than its melting point. The frozen ice cream bar was dipped into this mixture and then dried to form a coated ice cream bar incorporating the fiber crisps.

2. Granola Bar

| INGREDIENTS | Wt % |
|---|---|
| Krunch Fiber Crisps | 18.00 |
| Rolled Oats | 17.00 |
| High Maltose Corn Syrup | 13.93 |
| High Fructose Corn Syrup | 10.80 |
| Raisins | 7.00 |
| Cranberry Halves | 7.00 |
| Almond | 7.00 |
| MaizeWize Cereals¹ | 5.00 |
| Granulated Sugar | 3.60 |
| Soy Protein Crisps² | 3.00 |
| Fructose | 2.16 |
| Canola Oil | 2.02 |
| Molasses | 1.08 |
| Honey | 1.08 |
| Flavors | 0.72 |
| Salt | 0.36 |
| Lecithin | 0.18 |
| Citric Acid | 0.07 |

¹Corn flakes (corn flour, corn bran, wheat bran fraction, sugar, and salt) available from Cargill.
²Extruded crisp containing soy protein isolate and tapioca starch available from Cargill.

The granola bar was prepared by heating the high maltose corn syrup, high fructose corn syrup, molasses, honey, sugar, and fructose at 160-180° F. until the sugar crystals melted. The oil, lecithin, salt, citric acid, and flavors were then added to the syrup. The syrup was then added quickly to the pre-weight dry ingredients and mixed well to form a mass. The mass was then pressed into a single sheet measuring between 0.6 and 1.0 inches high, cooled, and then cut into bars.

3. Chocolate Bar

| Ingredient | Wt % |
|---|---|
| Chocolate | 83.57 |
| Fiber Crisps | 16.43 |
| Total | 100 |

The chocolate bar was prepared by heating the chocolate to 120° F., followed by cooling with agitation down to approximately 82° F., and then re-heating with agitation to approximately 88° F. The fiber crisps were then added to the chocolate, after which the composition was molded to form bars and then cooled to 45° F.

4. Protein Bar

| Ingredients | Wt % |
|---|---|
| HFCS, Isoclear 55¹ | 16.50 |
| Chocolate Coating | 16.00 |
| Corn Syrup, HM 43 | 15.50 |
| Whey Protein Isolate BiPro² | 7.50 |
| Calcium Caseinate 380³ | 7.50 |
| Soy Protein Isolate, 521⁴ | 7.50 |
| Maltodextrin 10 DE | 6.50 |
| Peanut Flour, 28% | 5.00 |
| Fiber Crisps | 5.00 |
| Glycerine #2001⁵ | 4.00 |
| Water | 3.50 |
| N Peanut Flavor FC 71120 | 3.00 |
| Peanut Butter, Red Fat | 2.50 |
| Total | 100.00 |

¹High fructose corn syrup available from Cargill.
²Available from New Zealand Milk Product.
³Available from Davisco Food International, Inc.
⁴Available from Cargill.
⁵Available from Golden Select Foods Co.

The protein bar was prepared by mixing the high fructose corn syrup (HFCS Isoclear 55), corn syrup, glycerin, water, peanut butter, and peanut flavor. The peanut flour and maltodextrin were then added, followed by mixing, after which the calcium caseinate, whey protein isolate, and soy protein isolate were added and mixed well. Next, the fiber crisps were added, followed by mixing to form a dough. The dough was molded to form a bar and then coated with the melted chocolate bar to form the final protein bar.

5. Cluster

| Ingredient | Wt % |
|---|---|
| High Maltose Corn Syrup, Satin Sweet 65¹ | 20.4 |
| Hazelnut Chopped | 15.2 |
| Fiber Crisps | 15.2 |
| Soy Crunch, ProSante 4P² | 10.2 |
| Oats, Steel Cut | 10.2 |
| Chocolate Chunks, Wilbur K895 Semisweet | 10.2 |
| Hazelnut Paste | 8.1 |
| Oats, Rolled | 5.1 |
| Chocolate Liqueur, Wilbur REO H365 | 3.1 |
| Sucromalt³ | 2.0 |
| Vanilla Extract | 0.2 |
| Salt | 0.2 |
| Hazelnut Flavor | 0.1 |

¹High maltose corn syrup available from Cargill.
²Textured soy flour available from Cargill.
³Available from Cargill.

The hazelnut paste, chocolate liqueur, and high maltose corn syrup were heated over a double boiler to a temperature of 165° F. to form a syrup. The vanilla extract was then added to the syrup. Next, the grains and nuts were added to the syrup until the syrup evenly coated the grains and nuts. The mixture was then removed from the heat and the chocolate chunks folded in. The resulting composition was spread onto the surface of a parchment-lined sheet pan and allowed to cool to room temperature to form a slab. The slab was then broken into pieces to form the clusters.

6. Batter and Breading

A batter was prepared by making a 40 wt. % solution of the following in cold water:

Batter

| Ingredient | Wt % |
|---|---|
| Pillsbury unbleached AP flour | 60.0 |
| Cargill Battercrisp 05530 Starch | 25.0 |
| Cargill Yellow Corn Flour | 8.0 |
| Non Iodized Salt | 6.0 |
| Baking Powder | 1.0 |

Crumbs were prepared by combining bread crumbs and the fiber crisps. In both cases, 20 mesh size particles were used. Chicken tenders were coated with the batter and then with the crumbs, after which the tenders were fried for 3 minutes at 375° F. in canola oil.

### Example Set B

A series of extruded crisps were prepared using a Wenger TX 57 extruder with an L/D ratio of 13.5:1. The composition of each crisp is set forth in Table B1, below. The extrusion conditions are set forth in Table B2, below. The following designations apply:

ActiStar™ RT 75330 is a phosphorylated resistant food starch derived from tapioca that is commercially available from Cargill, Inc.

StabiTex™ 06330 is a crosslinked waxy maize starch commercially available from Cargill, Inc.

StabiTex™ 06333 is a crosslinked waxy maize starch commercially available from Cargill, Inc.

ClearJel Modified Food Starch is a crosslinked waxy maize starch commercially available from National Starch and Chemical Corporation.

TABLE B1

| Sample | Amount (g) |
|---|---|
| Example 1 | |
| ActiStar RT 75330 | 65.00 |
| ClearJel Modified Food Starch | 35.00 |
| Example 2 | |
| ActiStar RT 75330 | 65.00 |
| StabiTex ™ 06333 | 35.00 |
| Example 3 | |
| ActiStar RT 75330 | 65.00 |
| StabiTex ™ 06333 | 35.00 |
| Example 4 | |
| ActiStar RT 75330 | 65.00 |
| StabiTex ™ 06330 | 35.00 |
| Example 5 | |
| ActiStar RT 75330 | 55.00 |
| StabiTex ™ 06330 | 35.00 |
| Oliggo-Fiber ® Instant Inulin | 10.00 |
| Example 6 | |
| ActiStar RT 75330 | 55.00 |
| StabiTex ™ 06333 | 35.00 |
| Polydextrose | 10.00 |
| Example 7 | |
| ActiStar RT 75330 | 50.00 |
| StabiTexTM 06333 | 35.00 |
| Inulin (instant) | 10.00 |
| Corn bran | 5.00 |

TABLE B2

| | Example | | | | | | |
|---|---|---|---|---|---|---|---|
| | 1 | 2 | 3 | 4 | 5 | 6 | 7 |
| Preconditioning | | | | | | | |
| information | | | | | | | |
| Speed (rpm) | 120 | 150 | 150 | 150 | 150 | 150 | 150 |
| Water Flow | 0.138 | 0.138 | 0.138 | 0.138 | 0.138 | 0.138 | 0.138 |
| (kg/hr) | | | | | | | |
| Discharge Temp | 75 | 75 | 72 | 73 | 74 | 76 | 76 |
| (° F.) | | | | | | | |
| Extrusion | | | | | | | |
| information | | | | | | | |
| Shaft Speed | 260 | 266 | 266 | 264 | 264 | 263 | 263 |
| (rpm) | | | | | | | |
| Motor load (%) | 55 | 54 | 62 | 62 | 58 | 58 | 55 |
| Water (kg/hr) | 0.088 | 0.088 | 0.093 | 0.093 | 0.093 | 0.093 | 0.093 |
| Knife Speed (%) | 70 | 61 | 61 | 61 | 63 | 63 | 63 |
| Setpoint/Actual- | 50/27 | 50/28 | 50/27 | 50/28 | 50/30 | 50/30 | 50/31 |
| 1^{st} Head (° C.) | | | | | | | |
| Setpoint/Actual- | 80/79 | 80/80 | 80/80 | 80/80 | 80/80 | 80/80 | 80/80 |
| 2^{nd} Head (° C.) | | | | | | | |
| Setpoint/Actual- | 100/101 | 100/100 | 100/100 | 100/100 | 100/100 | 100/100 | 100/100 |
| 3^{rd} Head (° C.) | | | | | | | |
| Die Space Temp | 118 | 118 | 118 | 119 | 115 | 115 | 114 |
| (° C.) | | | | | | | |
| Head Pressure (psi) | 300 | 250 | 300 | 300 | 300 | 300 | 300 |
| Die Pressure | 350 | 300 | 350 | 350 | 350 | 350 | 400 |
| (psi) | | | | | | | |

The amount of total dietary fiber (TDF) in each sample is set forth in Table B3, below. The TDF determinations were made according to AOAC 991.43. In the case of Examples 5-7, the results were adjusted to account for soluble fiber provided by the inulin or polydextrose components, and for fiber purity. The TDF results for Example 7 include TDF from resistant starch and corn bran. TDF¹ and TDF² refer to the fact that the include TDF determinations were made by two different entities. TDF % (theoretical) is calculated based upon the % TDF in the resistant starch ingredients and the % of the resistant starches in the final product.

TABLE B3

| | TDF % | | | |
|---|---|---|---|---|
| Example | (theoretical) | TDF¹ % | TDF² % | |
| 1 | 54.60 | 39.42 | n/a | |
| 2 | 54.60 | 44.12 | 33.6 | |
| 3 | 54.60 | 36.14 | 35.50 | |
| 4 | 54.60 | 37.40 | n/a | |
| 5 | 55.00 | n/a | 32.10 | (TDF) |
| | | | 6.81 | (inulin) |
| 6 | 45.1 | n/a | 21.8 | (TDF) |
| | | | 7.59 | (polydextrose) |
| 7 | 45.1 | n/a | 34.1 | (TDF) |
| | | | 6.91 | (inulin) |

These result demonstrate that crisps having high TDF values can be prepared.

A number of embodiments of the invention have been described. Nevertheless, it be understood that various modifications may be made without departing from the rit and scope of the invention. Accordingly, other embodiments are within the scope the following claims.

What is claimed is:

1. A crisp comprising a resistant starch and a puffing agent, wherein the crisp has a total dietary fiber content of at least 10% by weight.

2. A crisp according to claim 1 wherein the crisp has a total dietary fiber content of at least 20% by weight.

3. A crisp according to claim 1 wherein the crisp has a total dietary fiber content of at least 30% by weight.

4. A crisp according to claim 1 wherein the crisp has a total dietary fiber content of at least 40% by weight.

5. A crisp according to claim 1 wherein the resistant starch comprises a phosphorylated starch.

6. A crisp according to claim 1 wherein the resistant starch is derived from tapioca.

7. A crisp according to claim 1 wherein the resistant starch is derived from corn.

8. A crisp according to claim 1 wherein the resistant starch has an amylose content of at least 10% by weight.

9. A crisp according to claim 1 wherein the resistant starch has an amylose content of at least 50% by weight.

10. A crisp according to claim 1 wherein the resistant starch has an amylose content of at least 60% by weight.

11. A crisp according to claim 1 wherein the resistant starch has an amylose content of at least 80% by weight.

12. A crisp according to claim 1 wherein the resistant starch has an amylose content of at least 90% by weight.

13. A crisp according to claim 1 wherein the puffing agent is selected from the group consisting of corn starch, corn flour, corn meal, potato starch, potato flour, wheat starch, wheat flour, rice flour, tapioca starch, pregel corn meals, pregel whole corn flours and meals, and combinations thereof.

14. A crisp according to claim 1 wherein the puffing agent comprises a modified food starch.

15. A crisp according to claim 14 wherein the modified food starch comprises a crosslinked waxy maize starch.

16. A crisp according to claim 1 wherein the amount of the resistant starch is at least 45% by weight.

17. A crisp according to claim 1 wherein the amount of the resistant starch is at least 50% by weight.

18. A crisp according to claim 1 wherein the amount of the resistant starch is at least 60% by weight.

19. A crisp according to claim 1 wherein the amount of the puffing agent is no greater than 60% by weight.

20. A crisp according to claim 1 wherein the amount of the puffing agent is no greater than 35% by weight.

21. A crisp according to claim 1 wherein the crisp further comprises a fibrous ingredient selected from the group consisting of inulin, corn fiber, corn bran, beta glucans, psyllium, polydextrose, and combinations thereof.

22. A crisp according to claim 1 wherein the crisp has a color characterized by a red value of in the range of about 67.3 to about 77.3, and a yellow value in the range of about 56.2 to about 68.5.

23. A crisp according to claim 1 wherein the crisp has a crispness value of at least 13.5 when dry, as measured on a universal 15 point relational scale.

24. A crisp according to claim 1 wherein the crisp has a crispness value of at least 10.5 after immersion for 3 minutes in 2% milk, as measured on a universal 15 point relational scale.

25. A crisp according to claim 1, wherein the crisp has a crispness value of at least 9 after immersion for 6 minutes in 2% milk, as measured on a universal 15 point relational scale.

26. A crisp according to claim 1, wherein the crisp has a crispness value of at least 6.5 after immersion for 10 minutes in 2% milk, as measured on a universal 15 point relational scale.

27. A crisp comprising (a) at least 45% by weight of a resistant phosphorylated starch having an amylose content of at least 10% by weight, (b) a puffing agent comprising a modified food starch, and (c) a fibrous ingredient selected from the group consisting of inulin, corn fiber, corn bran, beta glucans, psyllium, polydextrose, and combinations thereof, wherein the crisp has a total dietary fiber content of at least 30% by weight.

28. A food product comprising a base food and a crisp according to claim 1.

29. A food product according to claim 28 wherein the base food is selected from the group consisting of baked goods, bars, cereals, trail mix, and combinations thereof.

30. A method of preparing a crisp comprising (a) providing an extrudable composition comprising a resistant starch and a puffing agent; and (b) extruding the composition to form a crisp having a total dietary fiber content of at least 10% by weight.
